(19) United States
(12) Patent Application Publication
(10) Pub. No.: US 2016/0177870 A1
(43) Pub. Date: Jun. 23, 2016

(54) Layered Carrier Seal

(71) Applicant: Caterpillar Inc., Peoria, IL (US)

(72) Inventor: Christian Sabotta, Washington, IL (US)

(73) Assignee: Caterpillar Inc., Peoria, IL (US)

(21) Appl. No.: 14/575,070

(22) Filed: Dec. 18, 2014

(51) Int. Cl. F02F 11/00

(52) U.S. Cl. CPC F02F 11/002

(57) ABSTRACT

A layered carrier seal assembly includes a retainer, a sealing path, and a seal element. The retainer has a plurality of layers and the retainer has a top and bottom surface. The sealing path is disposed along the retainer and includes a plurality of seal slots. Each seal slot is defined by a seal slot wall forming the seal slot through the retainer. The seal element is disposed along the sealing path on the top surface and the bottom surface. The seal element disposed on the top surface is interconnected to the seal element disposed on the bottom surface via the plurality of seal slots.

### TECHNICAL FIELD

This patent disclosure relates generally to a seal, and more particularly, to a carrier seal assembly and method of generating a seal in a carrier.

### BACKGROUND

As is generally known, an internal combustion engine is a type of engine in which combustion of a fuel with an oxidizer, such as air, occurs in a combustion chamber. The expansion of gases during combustion applies a force on the pistons of the engine, and the chemical energy of the fuel is transformed into mechanical energy. In general, internal combustion engine designs have three circuits of working fluids: (1) combustible air/fuel mixture; (2) coolant; and (3) motor oil for lubrication. In order to maintain good working order of the engine, it is important that these three working fluids do not intermix. It is well known to use seals to properly separate these working fluids. One particularly challenging location to seal is in and around the head gasket. The head gasket is disposed between the engine block and the cylinder head and, as such, seals the top of the combustion chamber as well as the fluid passages bored into the cylinder head. In order to address this issue, flexible seal element may be attached to the head gasket at the pushrod passageways to isolate each of the fluid connections between the cylinder block and the cylinder head.

If the head gasket does not properly seal the fluid passageways, significant problems, may result. For example, the coolant can also leak into the cylinders, which can cause hydrostatic locking of the cylinders and damage the catalytic converter in the exhaust system. These and other problems may damage the engine.

U.S. Pat. No. 7,401,404 ('404), entitled “Retainer Gasket Construction,” is directed to an improved fluid-tight sealing gasket. The '404 patent describes a seal with grooves that are coined or stamped into the metal retainer, upon which a flexible seal element is bonded. Each of the seal elements is molded into the corresponding grooves. The design of the '404 patent, however, relies primarily on the chemical bonding of the seal element onto the metal carrier. Inadequate bonding of the seal element may cause the seal element to detach from the metal carrier, which can result in failure of the seal.

Accordingly, there is a need for an improved seal and method for manufacturing a seal in a carrier.

### SUMMARY

The foregoing needs are met, to a great extent, by the present disclosure, wherein aspects of an improved carrier for a resilient seal are provided.

In one aspect, the disclosure describes a layered carrier seal assembly. The layered carrier seal assembly includes a retainer, a sealing path, and a seal element. The retainer has a plurality of layers and the retainer has a top surface and a bottom surface. The sealing path is disposed along the retainer and includes a plurality of seal slots. Each seal slot is defined by a seal slot wall forming the seal slot through the retainer. The seal element is disposed along the sealing path on the top surface and the bottom surface. The seal element disposed on the top surface is interconnected to the seal element disposed on the bottom surface via the plurality of seal slots.

In another aspect, the disclosure describes a retainer for a layered carrier seal assembly. The retainer includes a plurality of layers, a sealing path, a top surface, and a bottom surface. The sealing path is disposed along the retainer. The sealing path includes a plurality of seal slots. Each seal slot is defined by a seal slot wall forming the seal slot through the retainer.

In yet another aspect, the disclosure describes a method of manufacturing a layered carrier seal. In this method, a plurality of layers are formed. One or more of the plurality of layers have a plurality of seal slots formed therethrough. The plurality of layers are stacked to assemble the retainer. The retainer has a top surface and a bottom surface. The plurality of seal slots in the one or more of the plurality of layers are aligned to generate a seal path along the retainer. Each seal slot is defined by a seal slot wall forming the seal slot through the retainer. A seal element is formed along the sealing path on the top surface and the bottom surface. The seal element disposed on the top surface is interconnected to the seal element disposed on the bottom surface via the plurality of seal slots.

### BRIEF DESCRIPTION OF THE DRAWINGS

FIG. 1 is a perspective and partially exploded view of components of an internal combustion engine with a layered carrier seal located between the cylinder block and the cylinder head according to an aspect of the present disclosure.

FIG. 2 is a plan view of the layered carrier seal according to an aspect of the present disclosure.

FIG. 3 is a perspective view of a portion of the layered carrier seal of FIG. 2.

FIG. 4 is a perspective view of a partially disassembled portion of the layered carrier seal of FIG. 2.

FIG. 5 is an exploded view of the partially disassembled portion of the layered carrier seal of FIG. 2.

FIG. 6 is a cross-sectional view taken across the plane 6-6 of the layered carrier seal of FIG. 3.

FIG. 7 is a perspective view of a portion of a layered carrier seal according to another aspect of the present disclosure.

FIG. 8 is a perspective view of a partially disassembled portion of the layered carrier seal of FIG. 7.

FIG. 9 is a cross-sectional view taken across the plane 9-9 of the layered carrier seal of FIG. 7.

### DETAILED DESCRIPTION

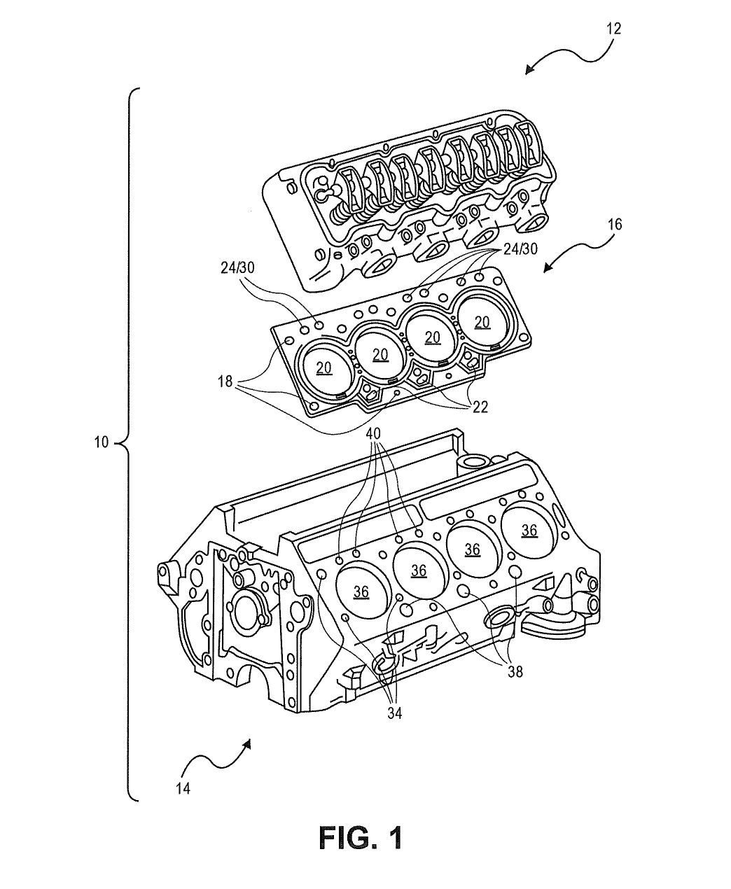

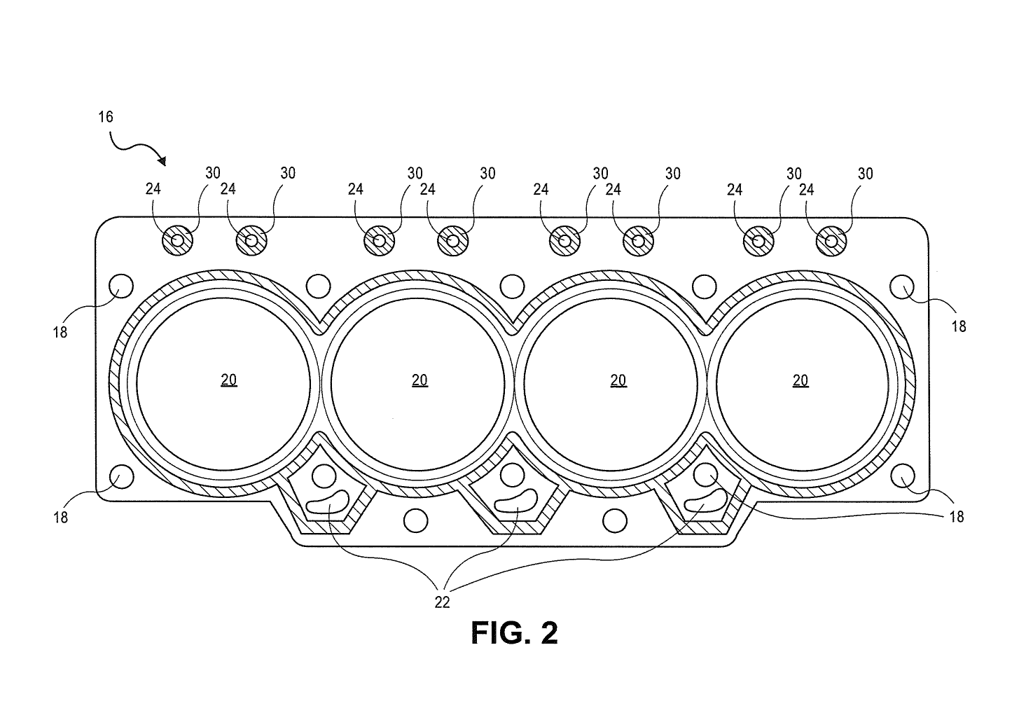

FIG. 1 shows components of an internal combustion engine 10 in accordance with an aspect of the present disclosure. The components of an internal combustion engine 10 include a cylinder head 12, a cylinder block 14, and a head gasket 16. As is generally understood, the head gasket 16 is disposed between the cylinder head 12 and the cylinder block 14 to form a seal therebetween. The head gasket 16 includes a plurality of bolt passages 18, a plurality of cylinder ports 20, one or more drain ports 22, and a plurality of pushrod ports 24. Any one or more of these features of the head gasket 16 may include an associated seal element 30 (shown in FIG. 2). However, for the sake of simplifying the disclosure, a particular example will be made of one of the pushrod ports 24 and the seal element 30 associated therewith. Of note, aspects of the disclosure are not limited to pushrod ports or head gaskets, but rather, are suitable for use with any seal or gasket. Moreover, although depicted in use with a V-8 engine, it will be readily recognized that this is exemplary and that the teachings of this disclosure can be applied to any type of engine and to gaskets utilized in any application requiring sealing of fluids.

The cylinder block 14 includes a plurality of threaded bores 34, a plurality of cylinder bores 36, a plurality of drain passages 38, and a plurality of pushrod passages 40. The plurality of threaded bores 34 correspond to the plurality of bolt passages 18. The plurality of cylinder bores 36 correspond to the plurality of cylinder ports 20. The plurality of drain passages 38 correspond to the plurality of drain ports 22. The plurality of pushrod passages 40 correspond to the plurality of pushrod ports 24. When assembled, bolts (not shown) extending out from the plurality of threaded bores 34 and passing through the plurality of bolt passages 18 are used to secure the cylinder head 12 to the cylinder block 14 with the head gasket 16 being sandwiched therebetween.

FIG. 2 is a plan view of the head gasket 16 in accordance with an aspect of the disclosure. As shown in FIG. 2, the seal element 30 may be disposed about some or all of the bolt passages 18, cylinder ports 20, drain ports 22, and pushrod ports 24 to facilitate forming a seal about these elements. The seal element 30 may include any suitable material. Examples of suitable materials generally include elastomers and/or deformable materials. The term “elastomeric” or “elastomer” may refer to a material that exhibits rubber-like properties of compliancy, resiliency, compression deflection, low compression set, flexibility, and an ability to recover after deformation. More particularly, suitable materials include natural rubbers, thermoplastic rubbers, thermosetting rubbers, vulcanizable rubbers, synthetic rubbers, such as fluoropolymers, chlorosulfonate, polybutadiene, buna-N, butyl, neoprene, nitril, polyisoprene, silicone, or copolymer rubbers such as ethylene propylene diene monomer (EPDM) rubber, nitrile butadiene rubber (NBR), and styrene-butadiene rubber (SBR), or a combination thereof. The term “synthetic rubbers” may also encompass other thermoplastic or thermosetting elastomers such as polyurethanes, silicones, etc. as well as other polymers that exhibit rubber-like properties such as plasticized nylons, polyesters, ethylene vinyl acetates, etc.

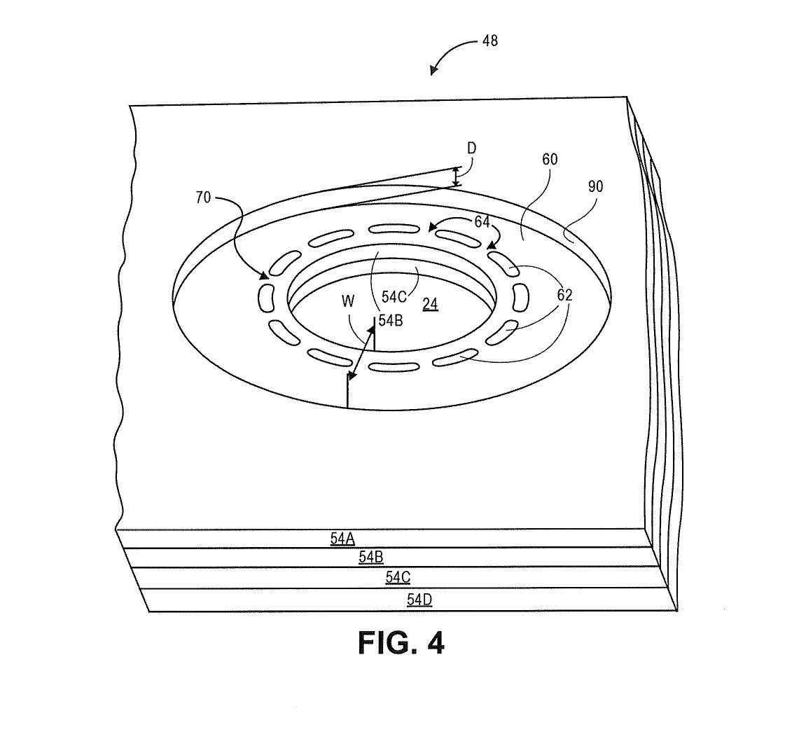

The bolt passages 18, cylinder ports 20, drain ports 22, and pushrod ports 24 are shaped and placed to function with the threaded bores 34, cylinder bores 36, drain passages 38, and pushrod passages 40 of the cylinder block 14 shown in FIG. 1. In order to form a respective seal about these ports and stop or reduce the intermixing of fluids passing therethrough, the seal element 30 respectively associated with each of these ports is retained in position. In this regard, the head gasket 16 includes a retainer 48 for the seal element 30. In general, the retainer 48 retains, provides structure, and/or provides gripping structures for the seal element 30. For example, as shown more clearly in FIG. 4, the retainer 48 includes a seal recess 60 and/or a plurality of seal slots 62. In general, one or both of the seal recess 60 and the plurality of seal slots 62 facilitate retaining the seal element 30 in position.

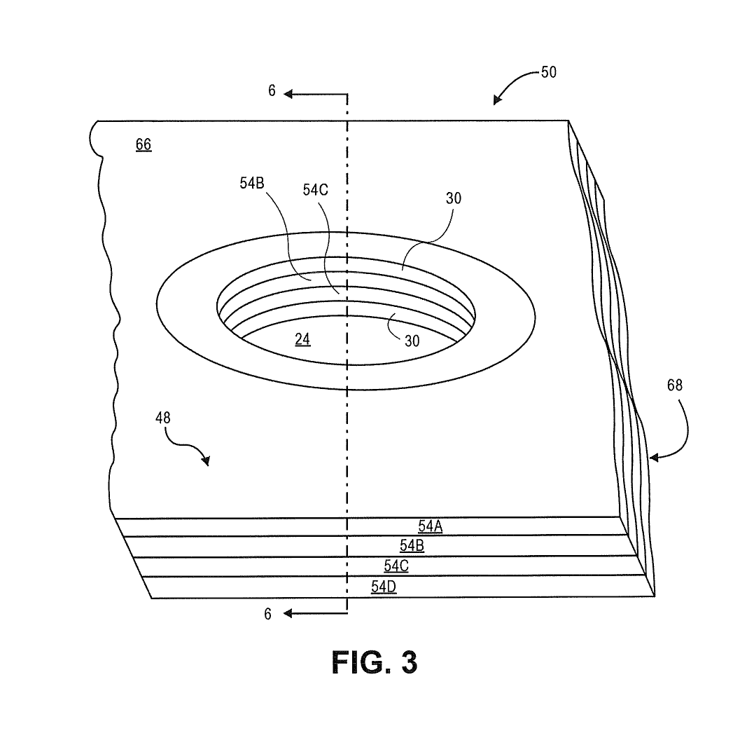

FIGS. 3-6 are views of a portion of the head gasket 16 shown in FIG. 2. As shown in FIGS. 3-6, the retainer 48 is a layered structure configured to retain the seal element 30 and, when assembled with the seal element 30, forms a layered carrier seal assembly 50. Of note, although the layered carrier seal assembly 50 is depicted as a head gasket in an internal combustion engine 10, the use of the layered carrier seal assembly 50 is not limited to a head gasket. The layered carrier seal assembly 50 may be configured for use in other applications where a fluid-tight seal is desired. These applications may include machine components where an integral seal, a stiff joint seal, or a metal on metal seal may be used. For example, the layered carrier seal assembly 50 may be useful in a hydraulic valve stack, a transmission, or a pump.

As shown in FIG. 3, the retainer 48 is made from a plurality of layers 54A-54D. Although four layers 54A-54D are shown, it may also be desirable to only have three layers or more than four layers depending on the intended application and desired thickness of the retainer 48. The plurality of layers 54A-54D can be made from any combination of suitable materials. Examples of suitable materials include metals, polymers, resins, composites, and the like. Examples of suitable metals includes aluminum, copper, bronze, steel, such as stainless steel, zinc plated steel, anodized steel, carbon steel, or some other metal. It may be desirable that different materials are selected for each of the plurality of layers 54A-54D depending on the intended application of the layered carrier seal assembly 50. For example, it may be desirable that the outer layers 54A and 54D are made from a stainless steel while the inner layers 54B and 54C are made from a hardened steel. The stainless steel selected for the outer layers 54A and 54D may prevent oxidation of the retainer 48, while the hardened steel selected for the inner layers 54B and 54C are configured to provide improved structural support for the retainer 48. Other combinations of materials for the plurality of layers 54A-54D may be used to achieve different desired properties of the retainer 48.

The plurality of layers 54A-54D may be bonded together using a bonding adhesive such as an epoxy, a phenol-formaldehyde based adhesive, a polyvinyl adhesive, or some other bonding adhesive that may be used for metal to metal bonding. The bonding of the plurality of layers 54A-54D may also rely on a simple friction fit or mechanical fit.

FIG. 4 is a perspective view of a partially disassembled portion of the layered carrier seal assembly 50 of FIG. 2. As shown in FIG. 4, the seal element 30 has been removed to show the seal recess 60 and the seal slots 62. As described herein, the plurality of layers 54A-54D are manufactured to produce the plurality of seal slots 62 and a plurality of bridges 64 disposed therebetween. For the purposes of this disclosure, the term “slot” and variations thereof is defined as a hole or passage of any suitable shape and/or size. Examples of suitable shapes include round, oval, rectangular, square, triangular, star shaped, discorectangular, and the like. The plurality of seal slots 62 are defined by the walls of the seal slots 62 formed in the layers 54A-54D. The plurality of layers 54A-54D are then stacked together to form the retainer 48. A notch or other visual indicator (not shown) along the sides of the plurality of layers 54A-54D may be used to assist in the alignment of the plurality of layers 54A-54D.

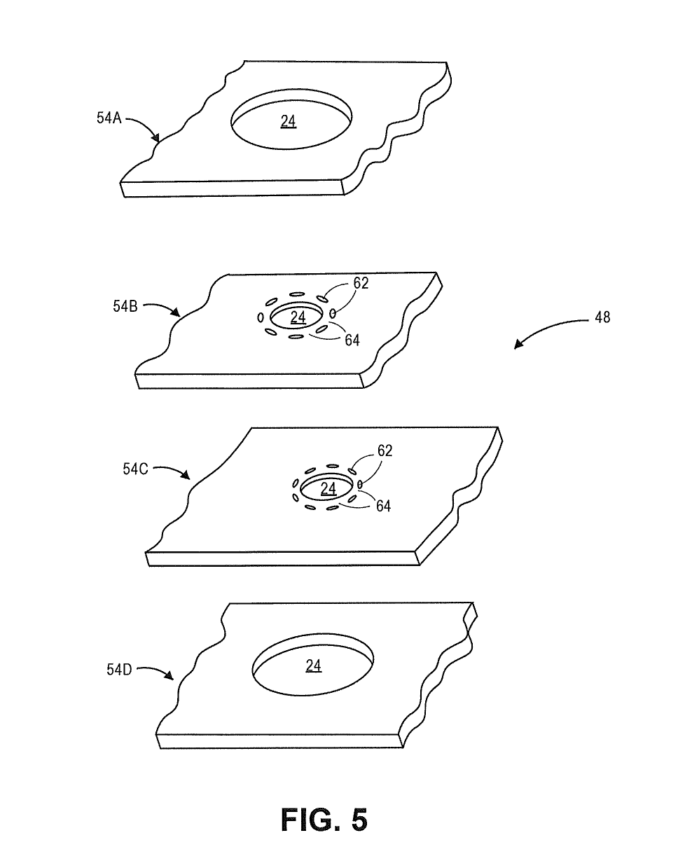

The plurality of layers 54A-54D are manufactured such that the seal recess 60 is formed in the retainer 48 when the plurality of layers 54A-54D are stacked together. The seal recess 60 is configured to provide a seat for the seal element 30 to at least partially reside. To form the seal recess 60 shown in FIG. 4, a larger bore is formed in the top layer 54A and the bottom layer 54D as compared to the bore formed in the inner layers 54B and 54C when forming the pushrod port 24 or other such fluid passage port in the retainer 48. The layers 54A-54D with different sized bores formed therethrough are shown in FIG. 5. The seal recess 60 may be formed on a top surface 66 and/or a bottom surface 68 of the retainer 48. The seal recess 60 can have a varying width (W) depending on the intended application of the layered carrier seal assembly 50. The seal recess 60 can also have a varying depth (D) depending on the intended application of the layered carrier seal assembly 50. As will be readily understood, the depth (D) of the seal recess 60 can be the same as the thickness of a single layer, or the combined thickness of two or more layers, of the retainer 48. The seal recess 60 facilitates retaining the seal element 30 in position by constraining the seal element 30 against a bearing surface 90. Although not shown, in other aspects, the seal recess 60 may include a groove or partial bore configured to constrain the seal element 30 within the bounds of a plurality of bearing surfaces 90.

The retainer 48 includes a sealing path 70 formed by the seal slots 62 and bridges 64 alternating along a path for the seal element 30. The seal element 30 is formed along the sealing path 70 by injecting, molding, or otherwise introducing the suitable material for the seal element 30 into the seal slots 62 and across the bridges 64 to form the seal element 30 along the sealing path 70. The seal slots 62 may have a rectangular shape, an elliptical shape, a polygonal shape, or some irregular shape depending on the intended use and the geometry of the retainer 48. The seal slots 62 can have uniform shape and size or differ depending on the location along the sealing path 70 for the seal element 30. As illustrated in FIG. 4, the seal slots 62 are implemented as discorectangular slots. Due to the spacing of the seal slots 62, the retainer 48 will have bridges 64 between the seal slots 62. In the aspect disclosed in FIG. 4, the bridges 64 are formed in the portion of the inner layers 54B and 54C between the seal slots 62. In other aspects, the bridges 64 can be formed in a portion of a single layer or additional layers, depending on the number of layers used to form the retainer 48.

Traditionally, seals that use a “hole and bridge” configuration have needed the seal slots 62 to be machined into the retainer 48 due to the thickness of the metal. In this disclosure the retainer 48 is assembled from plurality of layers 54A-54D, which are individually thinner than the retainer 48. It is desirable that the thickness of the plurality of layers 54A-54D be such that the plurality of layers 54A-54D may easily be machine stamped. This allows the seal slots 62 to be formed into each of the plurality of layers 54A-54D by a stamping process, which is efficient and cost effective. For example, the thickness of the retainer 48 may be any thickness for use between the cylinder head 12 and cylinder block 14 of an internal combustion engine 10 such as in the range of 0.1 to 2 inches. Conventionally, grooves and/or through bores of this depth are formed into a single piece of retainer 48 by milling or other time-consuming machining process. However, by individually stamping the plurality of layers 54A-54D, each with a thickness less than the overall thickness of the retainer and, for example, being in the range 0.0232 to 0.5 inches, the seal slots 62 may be formed more quickly and/or efficiently. It will also be recognized that one or more of the layers 54A-54D can have the same or different thicknesses as a result of the material used in for each layer or to achieve a desired overall thickness of the retainer 48.

In some aspects, it may also be desirable that the plurality of layers 54A-54D are stamped differently. This variation of the stamping can improve mechanical bonding of the seal element 30 to the retainer 48. As shown in FIG. 4, the outer layers 54A and 54D would be stamped differently from the inner layers 54B and 54C in order to form the seal recess 60.

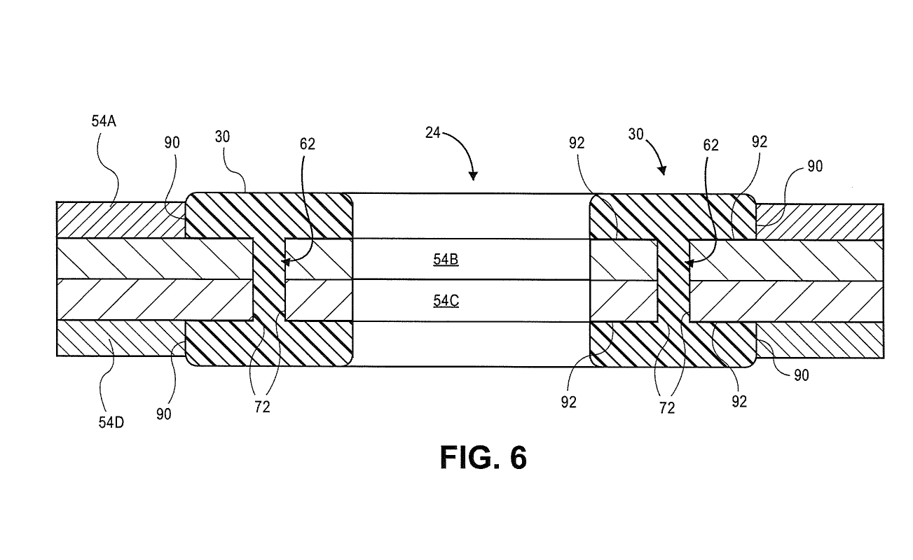

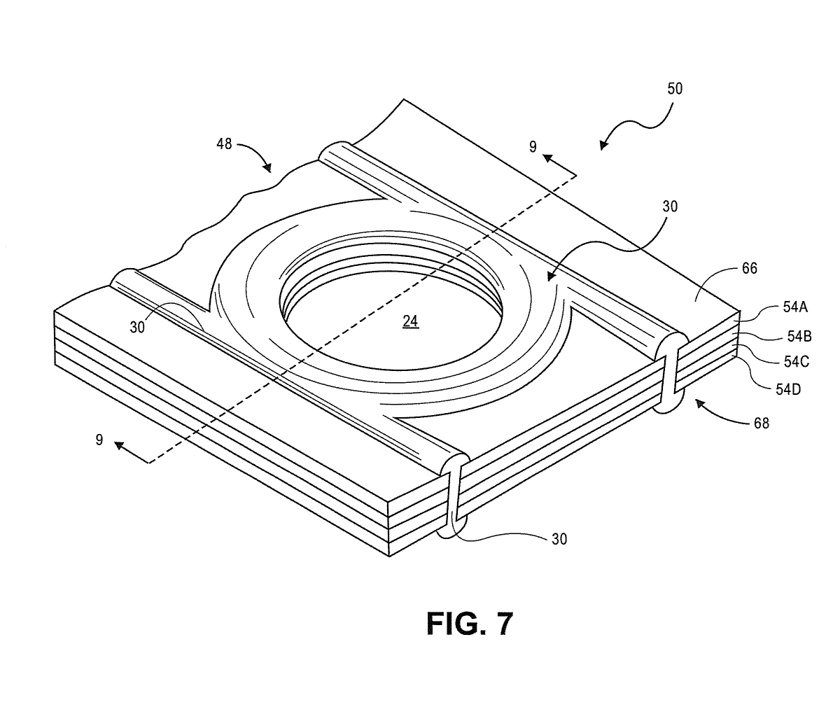

Once the plurality of layers 54A-54D are stacked together, the seal element 30 is bonded onto the top surface 66 and bottom surface 68 of the retainer 48 along the sealing path 70. The sealing path 70 is the surface on the top surface 66 of the retainer 48 that makes contact with the seal element 30. In addition sealing path 70 may be disposed on the bottom surface 68 of the retainer 48. That is, as shown in FIGS. 6 and 7, the seal element 30 is disposed on the top surface 66 and the bottom surface 68 and the seal element 30 on the top surface 66 is interconnected with the seal element 30 on the bottom surface 68 via the seal slots 62. The bonding of the seal element 30 can be accomplished by an adhesively bond, an interference fit, molding, or another method known in the art to adhere the seal element 30 onto the surfaces of the retainer 48.

If a molding process is used, the retainer 48 can be primed with siloxane, silane, or some other bonding agent 92 (shown in FIG. 6). Next, the retainer 48 may be placed into a heated mold cavity for the injection, compression, or transfer molding of an uncured rubber or other elastomeric compound to form the seal element 30. Subsequently, the seal element 30 can be formed and/or vulcanized onto the retainer 48. Alternatively or in addition to the bonding agent 92, in some aspects the molding process may urge uncured rubber or other elastomeric compound between the layers 54A-54D such that, when cured, may provide a mechanical bonding of the seal element 30 to the seal slots 62.

If an adhesive bond or interference fit is used to secure the seal element 30 onto the retainer 48, the retainer 48 is similarly primed with a siloxane, silane, or some other bonding agent 92. The seal element 30 is shaped into two or more pieces such that the seal element 30 fits into the seal slots 62 in the retainer 48. The pieces of the seal element 30 are then bonded onto the retainer 48 via a chemical bond or a frictional fit.

FIG. 6 shows a cross-sectional view along the plane 6-6 of FIG. 3 of the layered carrier seal assembly 50. The seal element 30 is bonded onto the retainer 48 around the bridges 64 and through the seal slots 62. The bridges 64 provide additional structural support for the bonding of the seal element 30 onto the retainer 48. As shown in FIG. 6, the seal slots 62 are defined by seal slot walls 72. That is, in response to the seal slot walls 72 being aligned in the layers 54B and 54C, the seal slot walls 72 define the seal slots 62. The seal slots 62 provide a passage for the seal element 30 through the retainer 48. In this manner, bonding of the seal element 30 to the retainer 48 is improved. For example, the seal slot walls 72 provide increased surface area for the seal element 30 to adhere. In addition, the seal slots 62 provide a mechanical advantage of connecting the seal element 30 through and then onto both sides of the retainer 48. That is, the seal slots 62 interconnect the seal element 30 disposed on the top surface (in this case, the top of layer 54B) with the seal element 30 disposed on the bottom surface (in this case the bottom of layer 54C). Furthermore, the seal slots 62 provide a mechanical advantage of allowing mechanical locking of the seal element 30 around the bridges 64 of the retainer 48. These improved bonding and mechanical locking advantages reinforce the connection of the seal element 30 to the retainer 48.

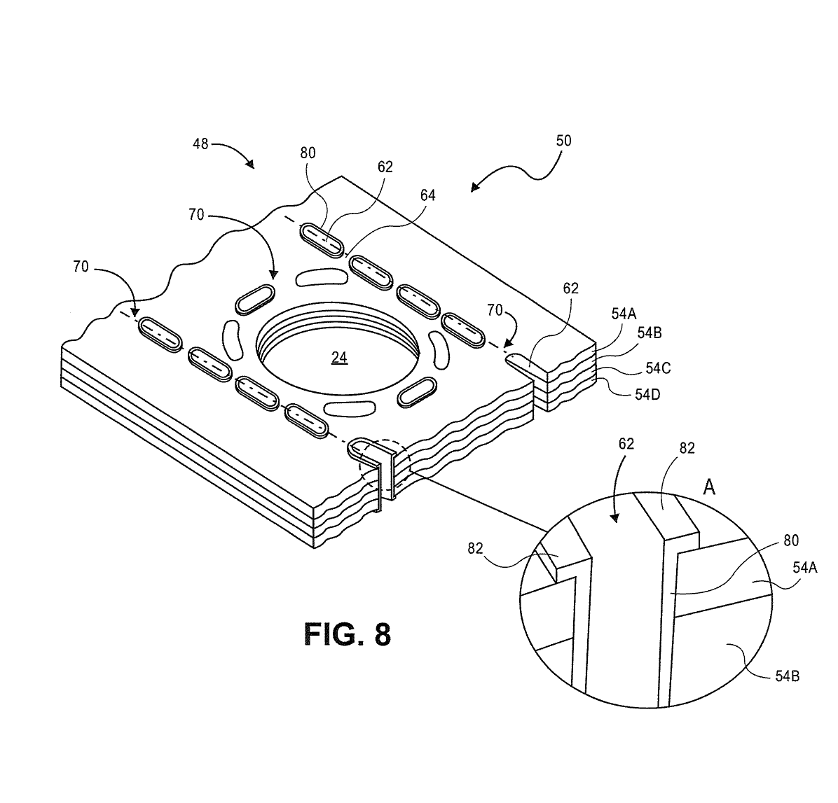

FIG. 7 illustrates another aspect of the layered carrier seal assembly 50. Similar to the layered carrier seal assembly 50 depicted in FIG. 3, the layered carrier seal assembly 50 in FIG. 7 also includes a retainer 48 made from plurality of layers 54A-54D with a seal element 30 bonded onto the retainer 48. As illustrated in FIG. 7, in some applications the seal recess 60 may be omitted from the retainer 48. As such, the seal recess 60 shown in FIG. 4 is optional. Instead of bonding the seal element 30 into a seal recess 60 (as depicted in FIGS. 3 and 4), the seal element 30 is bonded directly onto the top surface 66 and/or the bottom surface 68 of the retainer 48. It is an advantage of the example shown in FIGS. 7 and 8 that a single die or stamp may be used to form all the layers 54A-54D because a seal recess 60 may be omitted from the outer layers 54A and 54D. In this manner, the number of dies and/or manufacturing steps may be reduced when manufacturing the layered carrier seal assembly 50.

FIG. 7 also shows that the seal element 30 may be disposed anywhere along the retainer 48. That is, the layered carrier seal assembly 50 may be suitable for anywhere a gasket or seal may be suitable. For example, the layered carrier seal assembly 50 may be suitable to seal a chamber or housing (not shown). As such, the seal element 30 need not be disposed about a port such as the pushrod port 24, but rather, may be disposed anywhere on the retainer 48.

FIG. 8 illustrates another aspect of the layered carrier seal assembly 50. As shown in FIG. 8, the retainer 48 optionally includes one or more sleeves 80. If included, the sleeves 80 may be placed in respective ones of the plurality of seal slots 62 to provide a bonding element for the seal element 30 and/or reduce or prevent the seal element 30 from flowing between the layers 54A-54D. The sleeves 80 may include an outside surface configured to slide into and/or mate with an inside surface of the shape of the seal slots 62. Once in place, an edge of the sleeve 80 may be crimped or otherwise folded over the sides of the seal slots 62 to form a lip 82. The lip 82 is configured to retain the sleeve 80 in the seal slot 62. The sleeves 80 may include any suitable material. Examples of suitable materials include metals, polymers, paper, and the like. In a particular example, the sleeve 80 may include a metal foil. In another example, the sleeve 80 may include a polymer.

Also shown in FIG. 8, the sealing path 70 is disposed about the pushrod port 24 and the sealing path 70 is shown disposed along a line that is not associated with the pushrod port 24. That is, the seal element 30 and the sealing path 70 may be disposed anywhere along the retainer 48. In this manner, the sealing path 70 may provide the seal element 30 with increased adherence to the retainer 48 anywhere along the retainer 48.

The sleeves 80 may be used to hold the plurality of layers 54A-54D together before the seal element 30 is bonded onto the retainer 48. The seal element 30 is attached to the retainer 48 through the seal slots 62 and around the bridges 64. The seal element 30 also bonds through and over the sleeves 80. The finished layered carrier seal assembly 50 may appear similar to the illustration in FIG. 7 with the sleeves 80 underneath the seal element 30; however, the seal element 30 may be bonded to the retainer 48 with a different configuration.

The seal element 30 may be formed on the retainer 48 in any suitable manner. In general, how the seal element 30 is formed on the retainer 48 depends on the material used for the seal element 30. For example, rubber or rubber-like material may be injected or otherwise applied as a viscous liquid and cured via a vulcanizing process. During the vulcanization process of the seal element 30, the seal element 30 is heated to high temperatures, which may cause the seal element 30 to expand. In another example, a thermoset resin may also be applied as a viscous liquid and subjected to heat and/or pressure. In yet another example, a chemically cured polymer may be cured by mixing a monomer with a catalyst, applying the mixture, and allowing the mixture to cure. In these or other examples, a mold or form may be used to obtain a particular geometry of the seal element 30. In addition, prior to curing, the material for the seal element 30 may be introduced along the sealing path 70 with injectors or sufficient pressure to urge the uncured material into and through the seal slots 62 and/or the sleeves 80. In some examples, the sleeves 80 may be provided to reduce or prevent the material of the seal element from flowing between the plurality of layers 54A-54D. In other aspects, depending on the materials employed and the conditions used for the bonding of the seal element 30 to the retainer 48, the sleeves 80 may be omitted. For example, in some applications, it may be desirable that the seal element 30 flows between the plurality of layers 54A-54D.

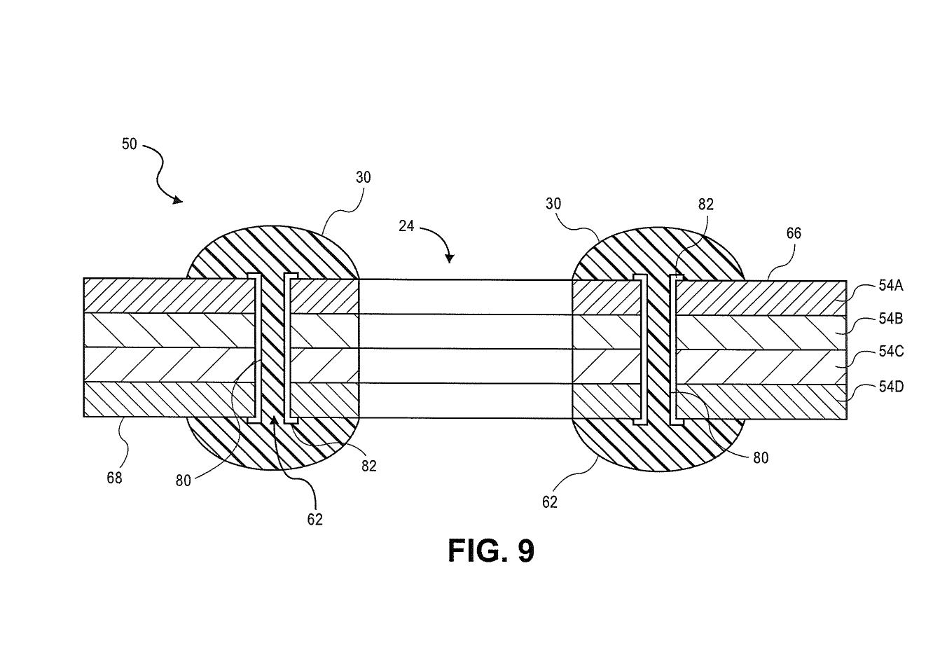

FIG. 9 shows a cross-sectional view along the plane 9-9 of FIG. 7 of the layered carrier seal assembly 50. As depicted, sleeves 80 are inserted into sleeve slots 62 and lips 82 are formed on the sleeves 80 at the top surface 66 and bottom surface 68 of the retainer assembly 50. As can be seen in FIG. 9, the seal element 30 is applied to the retainer 48 over the lips 82 on both the top surface 66 and the bottom surface 68 as well as through the sleeve slots 62. As can readily be understood, the sleeves 80 and lips 82 can be configured to provide one or more of a variety of functions including aligning the various layers 54A-54D of the retainer 48, fastening the layers 54A-54D together, and/or preventing the sealing element 30 from flowing between the layers 54A-54D.

### INDUSTRIAL APPLICABILITY

The present disclosure is generally applicable to seals used in any device where seals are conventionally utilized. More particularly, layered carrier seal assembly 50 disclosed herein may be applicable in sealing fluid ports, chambers, and housings of mechanical systems such as engines, transmissions, pumps, hydraulic systems, and the like. The engines can be used in power generation, hydraulic fracking, or to power other machinery such as vehicles. Although the disclosure has illustrated the layered carrier seal assembly 50 as a head gasket for use in an engine, the layered carrier seal assembly 50 can also be adapted for use in other applications where a seal is needed between two metal interfaces, such as in a hydraulic valve stack, a transmission, or a pump.

Generally, the layered carrier seal assembly 50 includes the retainer 48 formed from plurality of layers 54A-54D. The retainer 48 has a plurality of seal slots 62 formed by a stamping process. A seal element 30 is bonded onto the retainer 48 through the plurality of seal slots 62 and around the bridges 64 between the seal slots 62. This alternating set of seal slots 62 and bridges 64 define the sealing path 70 that the seal element 30 is disposed along. The bonding around the bridges 64 allows for mechanical locking of the seal element 30 onto the retainer 48, which offers improved performance over seals that rely primarily on the chemical bonding of the seal element 30 onto the retainer 48. Because the retainer 48 is made from plurality of layers 54A-54D, the seal slots 62 can be formed in the individual layers 54A-54D more quickly and/or efficiently than machining processes for making seal slots in thicker material. It is an advantage of some aspects described herein that the thinness of the individual layers 54A-54D compared to the stack of layers 54A-54D allow the seal slots 62 to be formed using a stamping process and allow the layers 54A-54D to be formed from different materials having different structural or chemical properties.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A layered carrier seal assembly, comprising:
a retainer including a plurality of layers, the retainer having a top surface and a bottom surface;
a sealing path disposed along the retainer, the sealing path including a plurality of seal slots, each seal slot being defined by a seal slot wall forming the seal slot through the retainer; and
a seal element disposed along the sealing path on the top surface and the bottom surface, wherein the seal element disposed on the top surface is interconnected to the seal element disposed on the bottom surface via the plurality of seal slots.

2. The layered carrier seal assembly according to claim 1, further comprising a plurality of bridges disposed along the sealing path, wherein the plurality of bridges and seal slots alternate along the sealing path.

3. The layered carrier seal assembly according to claim 1, further comprising a seal recess configured to provide a seat for the seal element to at least partially reside.

4. The layered carrier seal assembly according to claim 3, further comprising a bearing surface defining an edge of the seal recess and configured to confine the seal element therein.

5. The layered carrier seal assembly according to claim 1, further comprising a bonding agent disposed between the plurality of layers of the retainer.

6. The layered carrier seal assembly according to claim 1, further comprising sleeves disposed in the plurality of seal slots, wherein each of the sleeves is retained within a corresponding seal slot by a lip.

7. The layered carrier seal assembly according to claim 1, further comprising a port disposed through the retainer, wherein the sealing path is disposed about the port.

8. The layered carrier seal assembly according to claim 1, wherein at least one of the plurality of layers includes a first material and at least one other of the plurality of the layers includes a different material.

9. The layered carrier seal assembly according to claim 1, wherein the seal element is made from a material selected from the group consisting of a natural rubber, a vulcanized rubber, a synthetic rubber, and a blend thereof.

10. A retainer for a layered carrier seal assembly, the retainer comprising:
a plurality of layers, the retainer having a top surface and a bottom surface; and
a sealing path disposed along the retainer, the sealing path including a plurality of seal slots, each seal slot being defined by a seal slot wall forming the seal slot through the retainer.

11. The retainer according to claim 10, further comprising a plurality of bridges disposed along the sealing path, wherein the plurality of bridges and seal slots alternate along the sealing path.

12. The retainer according to claim 10, further comprising a seal recess configured to provide a seat for a seal element to at least partially reside.

13. The retainer according to claim 12, further comprising a bearing surface defining an edge of the seal recess and configured to confine the seal element therein.

14. The retainer according to claim 10, further comprising a bonding agent disposed between the plurality of layers of the retainer.

15. The retainer according to claim 10, further comprising sleeves disposed in the plurality of seal slots, wherein each of the sleeves is retained within a corresponding seal slot by a lip.

16. The retainer according to claim 10, further comprising a port disposed through the retainer, wherein the sealing path is disposed about the port.

17. The retainer according to claim 10, wherein at least one of the plurality of layers includes a first material and at least one other of the plurality of the layers includes a different material.

18. A method of manufacturing a layered carrier seal, comprising the steps of:
forming a plurality of layers of a retainer, at least one of the plurality of layers having a plurality of seal slots formed therethrough;
stacking the plurality of layers to assemble the retainer, the retainer having a top surface and a bottom surface;
aligning the plurality of layers to generate a sealing path along the retainer, each seal slot being defined by a seal slot wall forming the seal slot through the retainer; and
forming a seal element along the sealing path on the top surface and the bottom surface, wherein the seal element disposed on the top surface is interconnected to the seal element disposed on the bottom surface via the plurality of seal slots.

19. The method according to claim 18, further comprising the step of:
forming a seal recess in at least a second one of the plurality of layers, said seal recess configured to provide a seat for the seal element.

20. The method according to claim 18, wherein the plurality of layers includes a first subset of layers having a first material and a second subset of layers having a second material; and
assembling the retainer with the first subset of layers disposed to form the top surface and the bottom surface and the second subset of layers are disposed between the top surface and the bottom surface.
